(19) United States
(12) Patent Application Publication
(10) Pub. No.: US 2004/0024094 A1
(43) Pub. Date: Feb. 5, 2004

(54) Composition for coating sausages and hard cheeses

(76) Inventor: Heinz Stemmler, Koln (DE)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/275,365

(22) PCT Filed: May 2, 2001
(86) PCT No.: PCT/EP01/04903

(30) Foreign Application Priority Data
May 3, 2000 (EP) 00109404.4
Jun. 14, 2000 (EP) 00112561.6

(51) Int. Cl. C08L 1/00

(52) U.S. Cl. 524/77

(57) ABSTRACT

The present invention relates to a composition comprising an aqueous dispersion of shellac and a copolymer, to a process for preparing it, and to the use thereof for coating sausages having a natural or artificial sausage casing, and hard cheese.

The present invention relates to a composition comprising an aqueous dispersion of shellac and a copolymer of ethylene and vinyl acetate, to a process for preparing such aqueous dispersion, and to the use of the dispersion for coating foods selected from the group consisting of sausages having a natural or artificial sausage casing, and hard cheese. The invention further relates to a method for coating the mentioned foods with the composition according to the invention, and to sausages and hard cheese obtainable by the method according to the invention.

The commercially available sausages which have a natural or artificial sausage casing are raw sausages, cooked salamis, cooked sausages and boiled sausages. In spite of their natural or artificial sausage casing, raw sausages, also called long-keeping sausages, have the disadvantage that a measurable loss in weight of the food occurs due to losses of juice of meat through the casing. Due to this loss of juice of meat through the casing, these sausages are characterized by a fatty surface. In addition, the currently used casing which is insufficient in this respect causes a non-uniform coloring of the cross-section of the enclosed sausages from the interior of the sausage to the outer periphery. This is clearly visible, especially when the first cuts are made in the sausages, in the form of a more or less broad discolored region formed at the interface to the casing. This formation of discolored outer regions, which is frequently perceivable without difficulty in salami, a typical representative of raw sausages, is often even increased after the first cut is made. In sausages sealed in plastic sheets, the exit of moisture out of the sausage causes an accumulation of liquid between the surface of the sausage and the water-impermeable sheet. In addition, sausages untreated at the surface tend to produce mold upon storage.

Commercially available liver sausage (liverwurst), a typical representative of the cooked sausages, has an additional wax coating over the artificial or natural sausage casing. This wax coating serves to prevent contamination of the sausage and, independently thereof, the formation of spots on the surface of the sausage, which would occur after a short time without this additional coating. The wax coating usually consists of modified acetylated monoglycerides (EP-A-0 037 086). The wax coating is applied to the artificial casing of the liver sausage at temperatures of between 130 and 140° C., which requires particular methods and safety cautions. However, one particular disadvantage is the fact that the wax additionally adds to the weight of the sausages and is clearly perceivable beside the sausage casing when the sausage is cut.

Hard cheese is usually coated with a paraffin wax layer for preservation. After some time, however, the layer becomes brittle and cracked, and thus the purpose of preserving the enclosed hard cheese is no longer achieved. Further, in spite of the coating, there is often formation of discolored outer regions in the enclosed cheese.

WO-A-98/06271 describes a composition comprising an aqueous-ethanolic solution of shellac and polyamide for coating long-keeping sausages and hard cheese. The aqueous-ethanolic solvent contains at least 50% by weight of ethanol.

Now, it has been the object of the present invention to provide a composition which forms a well-adhering and closely conforming, clear and uniform film on the natural or artificial casing of sausages, which film replaces the above described coatings and packaging of the sausages and hard cheese and does not exhibit the respectively related drawbacks of these. The coating should be capable of being applied under mild conditions and with simple methods even on moist sausage casings and hard cheese to form a smooth, transparent and optically appealing and sufficiently elastic film thereon.

According to the present invention, this object is achieved by a composition comprising, in an aqueous dispersion:

(a) shellac; and

(b) An ethylene/vinyl acetate copolymer.

The composition according to the invention forms a stable and sufficiently elastic coating with no tendency to cracking on the surface of the sausage or hard cheese. The aqueous dispersion according to the invention quickly drops from the surface treated therewith to form a uniform coating film and quickly dries to form the desired coating. Another advantage of the composition according to the invention is the fact that the aqueous dispersion does not contain any alcohol. Containing alcohol usually requires that particular caution measures must be met in the shipping and application. Thus, compositions containing ethanol usually represent a hazard when shipped and, in addition, can be used only while particular safety provisions are being met.

The composition according to the invention can be used for the coating of foods which are selected from the group consisting of sausages having a natural or artificial sausage casing, and hard cheese. The coating provides sausages which have, on their natural or artificial sausage casing, a uniform, smooth, transparent and elastic permanent coating comprising the shellac and the copolymer which firmly adheres to the natural or artificial sausage casing. The same holds for the coating of hard cheese, in which case the coating is directly applied to the previously uncoated surface of the hard cheese.

The sausages which can be coated with the composition according to the invention are sausages having a natural or artificial sausage casing which is not intended for being eaten along with the sausage, especially raw sausages, cooked salamis, cooked sausages and boiled sausages. The raw sausages include all kinds of hard to soft raw sausages (hard and soft raw sausages), for example Ruegenwalder teewurst (soft raw sausage, without foreign water), salami or cooked salami (hard raw sausages). Typical cooked sausages include liver sausage and Thueringer rotwurst, and as typical representatives of boiled sausages, there may be mentioned mortadella, fleischwurst and cervelatwurst. As kinds of hard cheese, there can be employed all per se known kinds of cheese. The sausages and hard cheese can be wholly or partially coasted with the composition according to the invention.

The shellac to be used according to the invention can be any commercially available shellac. However, dewaxed shellac decolorized with active charcoal is preferred. Shellac is known to be very readily soluble in alcohol, especially ethanol or aqueous ethanol. However, within the scope of the invention, the shellac is used as an aqueous-alkaline solution which does not contain any alcohol or other organic solvents. The alkaline shellac solutions employed according to the invention contain from 15 to 35% by weight, preferably from 15 to 30% by weight, more preferably from 20 to 30% by weight, of shellac. The pH value of the ready-to-use shellac solution is from 7 to 8, preferably from 7.1 to 7.7, and more preferably to 7.4±0.1. The pH value can be adjusted by adding a suitable amount of sodium hydroxide, potassium hydroxide, sodium carbonate or potassium carbonate.

To prepare the aqueous-alkaline shellac solution to be employed according to the invention, the shellac to be dissolved, which is present in leaves or in a crushed or powdered form, is mixed with cold water in a container equipped with a stirrer and heating, and the amount of alkali required for dissolving the shellac is added. The amount of alkali added is just sufficient for the shellac to become dissolved. With stirring, the mixture is heated to from 30 to 70° C., preferably from 50 to 60° C., and stirred until the shellac is completely dissolved, which provides the above mentioned pH value. The ready-to-use composition according to the invention contains from 10 to 30% by weight, preferably from 10 to 25% by weight, more preferably from 13 to 22% by weight, of shellac.

The composition according to the invention contains from 5 to 30% by weight, preferably from 10 to 25% by weight, more preferably from 12 to 20% by weight, of the ethylene/vinyl acetate copolymer. Such ethylene/vinyl acetate copolymers have long been known in the prior art. The copolymers contain from 10 to 30% by weight, preferably from 15 to 25% by weight and more preferably from 16 to 20% by weight, of ethylene, based on the polymer. The ethylene/vinyl acetate copolymers are commercially available as aqueous copolymer dispersion. The solids content of such dispersions is between 45 and 60% by weight, preferably between 50 and 58% by weight, more preferably 55% by weight, and the pH value is between 3 and 5, preferably between 3.5 and 5 (ISO 1148), and the viscosity is between 3000 and 12,000 mPa's (23° C.), preferably between 5000 and 9500 (ISO 2555). Suitable copolymer dispersions are obtainable, for example, under the trade name of Mowilith®, commercial products of Clariant, Germany. According to the invention, it is particularly preferred to employ Mowilith® DM 105 or Mowilith® DM 1062, but any other vinyl acetate/ethylene copolymer dispersion which has the above described properties may also be employed.

The total concentration of shellac and ethylene/vinyl acetate copolymer in the composition according to the invention is up to 50% by weight, preferably up to 40% by weight and more preferably up to 35% by weight. For coatings with lower layer thicknesses on the sausages, lower concentrations are sufficient; for the coatings on the hard cheese, higher concentrations may be employed in order to achieve higher layer thicknesses.

The composition according to the invention may further contain up to 20% by weight, preferably up to 15% by weight, based on the aqueous dispersion, of additives selected from the group consisting of dyes or pigments (for example, titanium dioxide or iron oxide), or for hard cheese, yellow or red pigments. In addition, the composition according to the invention may further contain up to 2% by weight, preferably up to 1% by weight, of usual preservatives.

The aqueous composition according to the invention can be prepared by mixing the above defined aqueous solution of shellac with the above described aqueous ethylene/vinyl acetate copolymer dispersion. Thus, for example, the copolymer dispersion is added with stirring to the shellac solution to obtain the above mentioned total concentrations and weight proportions of shellac and copolymer. The mixing is effected at room temperature (20° C.). Optionally, the stirring of the two dispersions can be effected at elevated temperature, preferably at up to 30° C. The pH value of the ready-to-use composition according to the invention is between 7 and 9, preferably between 7 and 7.5, more preferably between 7.1 and 7.3. The pH value can be adjusted by adding alkalis, such as NaOH, KOH, Na₂CO₃or K₂CO₃. The composition according to the invention can be stored at room temperature over a period of several months.

According to the inventive method for coating the sausages having a natural or artificial casing and the hard cheese, these foods are surface-treated with the aqueous dispersion according to the invention. Such treatment may be effected by spraying or brushing the sausages or cheese with the optionally heated aqueous dispersion according to the invention, or the sausages or cheese are dipped therein. After such treatment, the treated sausages or cheese are allowed to dry in air whereby a layer consisting of shellac and the ethylene/vinyl acetate copolymer remains on the natural or artificial casing of the sausages or on the hard cheese, the shellac and the copolymer being present in the above stated weight proportions.

After said brushing, spraying or dipping of the products, the excess solution may also be drained, and the treated product may be passed through a suitable drying means in which the water evaporates in an air current at 10 to 50° C. depending on the nature of the treated product. Since these are only aqueous solutions, particular safety measures are not necessary. It is astonishing how the coating dries very quickly to form a uniform layer having a uniform thickness.

The final coating remaining on the product is a uniform, firmly adhering, mechanically stable, sufficiently elastic and transparent film which is also suitable for covering particularly problematic smooth sausages, such as Ruegenwalder, or also wet surfaces, such as in liver sausage, in a firmly adhering, permanently smooth and transparent way.

After the drying, the coating consists of a composition of shellac and the ethylene/vinyl acetate copolymer and the optionally contained additives.

The sausages and hard cheese obtainable by the method according to the invention may have protective films with a layer thickness of up to 1 mm. However, for sausages, layer thicknesses of up to 0.5 mm, preferably up to 0.2 mm and more preferably up to 0.1 mm are sufficient, whereas the surface of hard cheese may be provided with a shellac/copolymer coating having a layer thickness of up to 0.7 mm, preferably up to 0.5 mm and more preferably up to 0.4 mm. The minimum layer thickness with which a uniform coating can still be obtained and which yet provides the above stated advantages in either case is 0.001 mm, preferably 0.005 mm, more preferably 0.01 mm.

The mentioned layer thicknesses can be achieved by adjusting corresponding shellac/copolymer concentrations of the aqueous dispersion and thus the viscosity of the composition according to the invention. However, this must be decided in each individual case and is essentially dependent on the kind of product to be coated.

The combination of shellac and ethylene/vinyl acetate copolymer for coating the above mentioned foods has the advantage, as compared to coating the foods with films of the respective ethylene/vinyl acetate copolymer (coated alone), inter alia, that the film according to the invention results in an optically appealing surface, in particular, on the natural or artificial casing around the surface of the sausage. Due to the tight contact of the films according to the invention, contamination of the surface of the sausage in the space between the surface of the sausage and the coating is avoided. Mold formation could be further reduced as compared to coatings of shellac/polyamide according to WO-A-98/06271. This is a considerable advantage, in particular, under warm and wet conditions. The coating according to the invention is essentially more flexible as compared to the shellac/polyamide coating according to WO-A-98/06271 and as compared to a coating which solely consists of shellac. A coating of the ethylene/vinyl acetate copolymer alone has poor drying properties, an offensive smell and in addition, and above all, does not result in the desired properties, especially the desired slow-down of the weight reduction in the raw sausages.

With a shellac coating alone, the non-uniform discoloring of the enclosed sausages and cheese (formation of discolored outer regions) cannot be avoided. In addition, a coating of shellac alone is too brittle and therefore scales off.

The raw sausage and cheese products coated according to the invention are substantially less perishable and do not exhibit any formation of discolored outer regions in the enclosed sausage or cheese even after prolonged periods of storage. Mold formation is not observed even under wet and warm conditions. In addition, the surface of the coated product obtains an appealing appearance due to its matte luster. Despite the advanced maturation of the products, the weight loss usually connected therewith is significantly reduced.

In the cooked and boiled sausages coated according to the invention, the heavy wax coating, in terms of weight proportion, could be replaced by the optically appealing and permanently elastic coating film according to the invention, and the properties achieved with the conventional wax coatings, which become brittle over time, could even be improved.

The invention will be described by the following Examples relating to the coating of a hard raw sausage (salami) and a liver sausage (cooked sausage). The results obtained for the loss in weight over a given period of time and formation of discolored outer regions are taste are found to the same extent and in the same quality in the coating of other raw sausages (long-keeping sausages) and hard cheese with the compositions according to the invention. Therefore, the invention is not limited to this concrete example.

### EXAMPLES

### 1. Coating Composition

For performing the Examples described below, shellac (grade E904, melting temperature 65-85° C., acid number 65-80, saponification number 180-240, maximum wax content 0.2% by weight, maximum drying loss 2.0% by weight, commercial products of Wolff & Olsen or of Hanse Products Gutschke, each of Hamburg) was employed. The preparation of the aqueous-alkaline shellac solution was effected as set forth in the description. The shellac solution employed for mixing with the aqueous copolymer was 20% by weight, and its pH value was 7.3. The stated weight percent of the aqueous shellac solution in the following Table are based on the 20% by weight solution employed.

As the ethylene/vinyl acetate copolymer, Molowilith® DM 105 (copolymer A) or Mowilith® DM 1062 (copolymer B), commercial products of Clariant, Germany, having a solids content of 55% by weight each were employed. The stated % by weight of the copolymer A/B dispersions in the following Table are based on the weight proportions of the respectively employed 55% by weight aqueous dispersion. The ready-to-use coating composition was obtained by stirring the shellac solution with the aqueous copolymer dispersion in the weight proportions stated in the Table and had a pH value of 7.2. The ready-to-use coating composition did not contain any additional preservatives.

### 2. Coating of a Hard Raw Sausage

The salami was briefly dipped into the respective coating composition and dried in air under respectively identical conditions. Then, the coated raw sausages were stored under identical conditions for 27 days. A comparative experiment, which was also performed, but not stated in the following Table, using a shellac coating of shellac (applied in an analogous way from a conventional aqueous-ethanolic shellac solution) did not yield a useful coating (scales off). The results stated in the following Table were established as the mean value of five individual determinations. The cutting surface of the sausages was uniformly red in all cases and did not exhibit formation of a discolored outer region. The sausages treated according to the invention (experiments 1 to 3) did not exhibit any mold formation on the surface even after 27 days of storage, whereas the untreated sausages (experiment 5) produced mold already after a few days.

TABLE

| Experiment | | | | | |
|---|---|---|---|---|---|
| No. | 1 | 2 | 3 | 4 (comparative) | 5 (comparative) |
| Composition | 75% by weight of the | 70% by weight of the | 70% by weight of the | 30% by weight of the | untreated |
| | shellac solution | shellac solution | shellac solution | copolymer A | |
| | 25% by weight of the | 30% by weight of the | 30% by weight of the | dispersion; | |
| | copolymer A | copolymer A | copolymer B | water as the balance | |
| | dispersion | dispersion | dispersion | | |
| Weight loss | 16.4 | 17.4 | 14.0 | 24.0 | 24.4 |
| in % | | | | | |
| Flexibility | Very flexible. Coating | Very flexible. Coating | Very flexible. Coating | Very flexible. Coating | |
| test | does not detach from | does not detach from | does not detach from | does not detach from | |
| | the surface of the | the surface of the | the surface of the | the surface of the | |
| | sausage even under | sausage even under | sausage even under | sausage even under | |
| | extremely high | extremely high | extremely high | extremely high | |
| | loading. | loading. | loading. | loading. | |
| Appearance of | Reddish, slightly | Reddish, slightly | Reddish, somewhat less | Reddish, matte. | Reddish, matte. |
| the outer | lustrous. | lustrous. | lustrous than 1 and 2. | | |
| surface of | | | | | |
| the sausage | | | | | |
| Sensory tests | Smell unobjectionable, | Smell unobjectionable, | Smell unobjectionable, | Smell unobjectionable, | Smell unobjectionable, |
| | taste very good. | taste very good. | taste very good. | taste good. Somewhat | taste good. Somewhat |
| | | | | more salty and clearly | more salty and clearly |
| | | | | harder to bite than 1, 2 | harder to bite than 1, 2 |
| | | | | and 3. | and 3. |

1. A composition comprising, in an aqueous dispersion:
a) shellac; and
b) a copolymer of ethylene and vinyl acetate.

2. The composition according to claim 1, characterized by containing:
a) from 10 to 30% by weight of shellac; and
b) from 5 to 30% by weight of the ethylene/vinyl acetate copolymer.

3. The composition according to claim 1 or 2, characterized by containing the shellac and the ethylene/vinyl acetate copolymer in a total concentration of up to 50% by weight.

4. The composition according to any of claims 1 to 3, characterized by having a pH value of from 7 to 9.

5. The composition according to any of claims 1 to 4, characterized in that said ethylene/vinyl acetate copolymer contains from 10 to 30% by weight of ethylene, based on the copolymer.

6. A process for preparing the aqueous dispersion according to any of claims 1 to 5 by mixing:
a) an aqueous solution of shellac; with
b) an aqueous ethylene/vinyl acetate copolymer dispersion.

7. The process according to claim 6, characterized in that said aqueous shellac solution contains from 15 to 35% by weight of shellac.

8. The process according to claim 6, characterized in that said aqueous ethylene/vinyl acetate dispersion has a solids content of from 45 to 60% by weight.

9. The process according to any of claims 6 to 8, characterized in that said mixing of the shellac dispersion and the copolymer dispersion is effected at such a ratio that the final concentration is from 10 to 30% by weight of shellac and from 5 to 30% by weight of copolymer, based on the total dispersion.

10. The process according to any of claims 6 to 9, characterized in that the pH value of said aqueous shellac/copolymer dispersion is adjusted to from 7 to 8.

11. Use of the composition according to any of claims 1 to 5 for the partial or complete coating of foods selected from the group consisting of sausages having a natural or artificial sausage casing, and hard cheese.

12. The use according to claim 11, characterized in that said sausages having a natural or artificial sausage casing are selected from the group consisting of hard and soft raw sausages, cooked salamis, cooked sausages and boiled sausages.

13. The use according to claim 12, characterized in that said sausages are selected from the group consisting of salami, Ruegenwalder, cooked salami, liver sausage (liverwurst), Thueringer rotwurst, mortadella, fleischwurst and cervelatwurst.

14. A method for coating foods selected from the group consisting of sausages having a natural or artificial sausage casing, and hard cheese, by treating the surface of said sausages or hard cheese with the aqueous dispersion as defined in any of claims 1 to 5.

15. The method according to claim 14, characterized in that said coating is effected by dipping, spraying or brushing with said aqueous dispersion.

16. The method according to claim 14, characterized in that the coating of the treated sausages or cheese is subsequently dried in a current of air at a temperature of from 10 to 50° C.

17. The method according to claim 14, characterized in that the dry coating has a layer thickness of up to 1 mm.

18. Foods selected from the group consisting of sausages having a natural or artificial sausage casing, and hard cheese, obtainable by the method as defined in any of claims 14 to 17.

19. The foods according to claim 18, characterized in that said sausages are selected from the group consisting of salami, Ruegenwalder, cooked salami, liver sausage (liverwurst), Thueringer rotwurst, mortadella, fleischwurst and cervelatwurst.
